(19) United States
(12) Patent Application Publication
(10) Pub. No.: US 2006/0213157 A1
(43) Pub. Date: Sep. 28, 2006

(54) Wall-embeddable air processing apparatus

(76) Inventors: D. Scott Kalous, Kenosha, WI (US); Charles Harris, Lincoln City, OR (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/091,101

(22) Filed: Mar. 28, 2005

(51) Int. Cl. B01D 50/00

(52) U.S. Cl. 55/385.2

(57) ABSTRACT

An example wall-embeddable air processing apparatus includes a cabinet having substantially parallel first and second surfaces and a plurality of air filter elements located within the cabinet. The air filter elements are arranged so that filtration surfaces of the filter elements are substantially coplanar to each other and substantially parallel to the first and second surfaces. An intake vent is operatively coupled to the cabinet and configured to enable ambient air to be drawn into the cabinet. A fan is operatively coupled to the cabinet and configured to draw the ambient air into the cabinet and to cause the ambient air to flow through the plurality of air filter elements to generate processed air.

### FIELD OF THE DISCLOSURE

The present disclosure relates generally to air processing apparatus and, more particularly, to wall-embeddable air processing apparatus.

### BACKGROUND

Concern over air quality has triggered much interest and many developments in the area of indoor air quality improvement and/or control. Such developments have resulted in the production of various types of air processing devices including air filtration apparatus. Air filtration apparatus are often differentiated according to air filtering capabilities and generally include air filtration devices designed to be integrated within a heating, ventilation, and air conditioning (HVAC) system and local or unitary air filtration devices. Air filtration devices configured to be integrated with HVAC systems (i.e., integrated air filtration devices) are typically capable of filtering large amounts of ambient air such as, for example, an amount of ambient air that fills a warehouse, an office building, an apartment building, a house, an entertainment hall, etc. In contrast, local or unitary air filtration devices are typically configured to filter an amount of ambient air associated with a local area such as, for example, an office, a bedroom, a bathroom, etc.

Integrated air filtration devices are typically large, bulky, and aesthetically unpleasing devices that are usually installed, for example, in a ceiling plenum, in a mechanical room, on a building roof top or otherwise outside of a building or structure, etc. By installing such integrated area air filtration devices in plenum spaces, on the outside of buildings, etc., integrated air filtration devices do not occupy valuable space (e.g., living space, work space, etc.) within the buildings and remain hidden from the view of building occupants.

In contrast, local or unitary air filtration devices are typically physically smaller than integrated air filtration devices. Local or unitary air filtration devices are typically employed by individuals to improve the air quality within an immediate or local area such as, for example, an office, a family room, a bathroom, etc. In addition, the local or unitary air filtration devices are typically designed to be placed in locations that are within the view of occupants of the locations. For example, the physical structures (e.g., enclosure or housing components) of these air filtration devices may be designed to be aesthetically pleasing and/or to be as unobtrusive as possible in view of other objects (e.g., furnishings, decor, etc.) that are typically present in the occupied spaces or areas.

Each type of air filtration device is typically configured to target specific filtering needs or requirements. For example, HVAC system integrated air filtration devices are configured to filter large amounts of ambient air over extended periods of time. In many cases, a considerable amount of time is required to filter all of the air within an entire building or structure. This is often acceptable for structures requiring minimal air filtration or that experience a relatively low rate of air quality degradation. In buildings or structures within which the rate of air quality degradation is relatively low, an HVAC system integrated air filtration device may operate only occasionally to maintain an acceptable air quality rating. However, in other buildings or structures such as, for example, bars, casinos, night clubs, etc., within which the rate of air quality degradation is relatively high, the integrated air filtration device may work continuously to maintain an acceptable air quality. In some cases, structures having higher rates of air quality degradation require larger HVAC system integrated air filtration devices. Many buildings or structures have multiple areas or spaces, each of which has a different air quality degradation rate and/or characteristic. Such areas or spaces may include high traffic (e.g., high occupancy density) areas smoking areas, non-smoking areas, etc. However, HVAC system integrated air filtration devices are typically configured to filter all or many areas within a structure at the same time and in the same manner (e.g., evenly). As a result, such HVAC system integrated air filtration devices are unable to filter the air in some areas more than other areas.

An alternative or additional approach to addressing the needs of spaces having larger rates of air quality degradation and/or a plurality of areas having different air quality degradation rates involves the use of a local or unitary air filtration device in each of the spaces and/or areas. In this manner, each of the air filtration devices may operate according to the air quality degradation of its corresponding area or space. For example, an air filtration device in one area or space may be operated at a different air filtration rate than an air filtration device located in another area or space.

Installing or locating a local or unitary air filtration device in a space or area consumes a certain amount of space (e.g., floor space). The space occupied by the local air filtration device could otherwise be used as functional space within the space or area. One solution to reduce the amount of space required by local air filtration devices involves installing local air filtration devices in ceiling plenums. In this manner, the local air filtration devices do not occupy valuable space. However, this technique is often limited to buildings or structures having large ceiling plenums that can accommodate the dimensions of a local air filtration device. For example, in houses, using local air filtration devices in plenums is often limited to installation in attics. Installation of local air filtration devices between a ceiling and a floor of a house would be difficult if not impossible because of the relatively limited space provided between the adjacent ceiling and floor.

### BRIEF DESCRIPTION OF THE DRAWINGS

FIGS. 1, 2, and 3 illustrate example wall-embeddable air processing apparatus.

FIG. 4A is a front elevational view and FIGS. 4B and 4C are example cross-sectional views of the example wall-embeddable air processing apparatus of FIG. 1.

FIG. 5A is a front elevational view and FIG. 5B is an example cross-sectional view of the example wall-embeddable air processing apparatus of FIG. 2.

FIG. 6A is a front elevational view and FIG. 6B is an example cross-sectional view of the example wall-embeddable air processing apparatus of FIG. 3.

### DETAILED DESCRIPTION

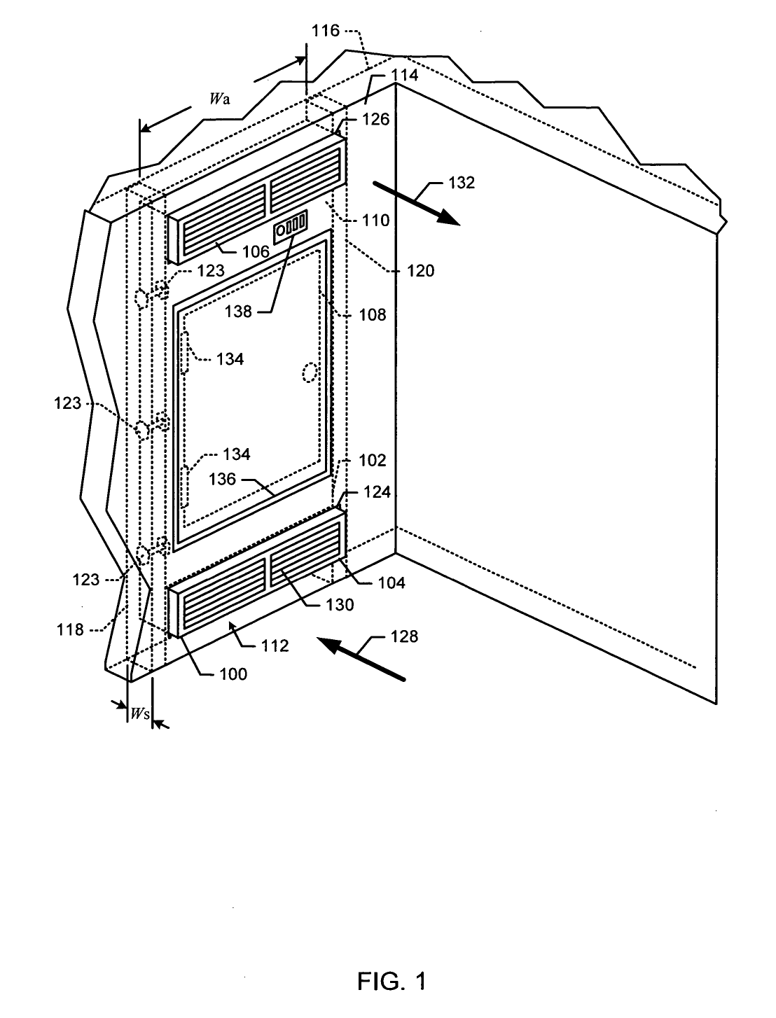

FIGS. 1, 2, and 3 illustrate example wall-embeddable air processing apparatus 100, 200, and 300. The example wall-embeddable air processing apparatus 100, 200, and 300 may be configured to process ambient air within a room, space, area, etc. As described in greater detail below, each of the example wall-embeddable air processing apparatus 100, 200, and 300 (i.e., the wall-embeddable air processing apparatus 100, 200, and 300) may include an air filtration apparatus configured to draw ambient air from an area, room, space, etc. and generate filtered air. Each of the wall-embeddable air processing apparatus 100, 200, and 300 may function as a local or unitary air processing apparatus that processes air within a local area. However, unlike typical local or unitary air processing apparatus, the wall-embeddable air processing apparatus 100, 200, and 300 may be disposed, recessed, or held at least partially within a wall structure so that a minimum amount of otherwise usable space within an area or room is occupied by the wall-embeddable air processing apparatus 100, 200, and 300.

In particular, the wall-embeddable air processing apparatus 100 shown in FIG. 1 includes a cabinet 102, an intake vent 104, an exhaust vent 106, and an access door 108. The cabinet 102 includes a front surface 110 and a rear surface (not shown) opposite and offset from the front surface 110. In addition, the cabinet 102 is configured to hold at least a portion of an air processing apparatus that is configured to be disposed or captured within a space defined by the surfaces (e.g., the front surface 110 and the back surface) of the cabinet 102.

The cabinet 102 may be configured to be disposed, held, or mounted substantially within a wall structure 112. In general, wall structures such as the wall structure 112 include a plurality of wall studs disposed between two wall panels, which are typically fastened to or otherwise mechanically fixed to the wall studs. As shown in FIG. 1, the wall structure 112 includes a first wall panel 114, a second wall panel 116, a first wall stud 118, and a second wall stud 120.

The first wall stud 118 and the second wall stud 120 are disposed within or captured between the wall panels 114 and 116 (i.e., inside the wall). Typically, wall studs such as the wall studs 118 and 120 are separated or spaced from one another by a standard distance. For example, one example standard dictates that wall studs should be located in wall structures every sixteen inches. Although, a width Wa of the cabinet 102 may be configured so that the cabinet 102 of the wall-embeddable air processing apparatus 100 fits between wall studs separated by sixteen inches, the cabinet 102 may be configured to have any width. In addition, any of the wall-embeddable air processing apparatus 100, 200, and 300 may be configured to be disposed within wall structures having wall studs that are separated by any distance.

The wall panels 114 and 116 are typically fastened or mechanically coupled or fixed to the wall studs 118 and 120 and separated from one another by a distance defined by a width Ws of the wall studs 118 and 120. As shown in FIG. 1, the cabinet 102 is configured to be captured between the first wall panel 114 and the second wall panel 116 so that the front surface 110 is adjacent to the back or inwardly facing side of the first wall panel 114 and the back surface of the cabinet 102 is adjacent to the inwardly facing side of the second wall panel 116. Thus, the depth of the cabinet 102 and the air processing apparatus held therein may be configured to fit within a space defined by the width Ws of the wall studs 118 and 120.

The position of the wall-embeddable air processing apparatus 100 may be fixed within the wall structure 112 using any suitable technique. For example, as shown in FIG. 1, the cabinet 102 may be abutted to the wall studs 118 and 120, which act as support members for the wall-embeddable air processing apparatus 100. The cabinet 102 may be mechanically coupled, fastened, or mounted to the wall studs 118 and 120 so that the front surface 110 and the back surface of the cabinet 102 are substantially parallel to the first wall panel 114 and the second wall panel 116. Specifically, a plurality of fasteners 123 (e.g., screws, anchors, etc.) may be used to mechanically couple the cabinet 102 to the wall stud 118 and another plurality of fasteners (not shown) opposite the plurality of fasteners 123 may be used to mechanically couple the cabinet 102 to the wall stud 120. Of course, the wall-embeddable air processing apparatus 100 may be fastened to other types of support members (e.g., wood support members, metallic support members, etc.) that do not function as wall studs, but are embedded within or otherwise fastened to a wall structure (e.g., the wall structure 112).

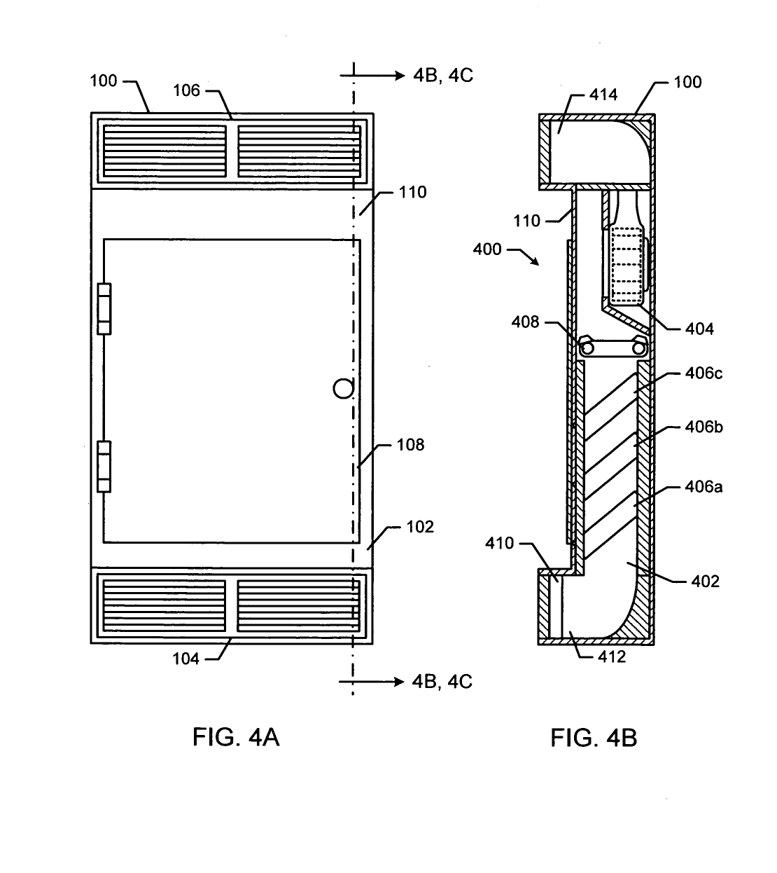

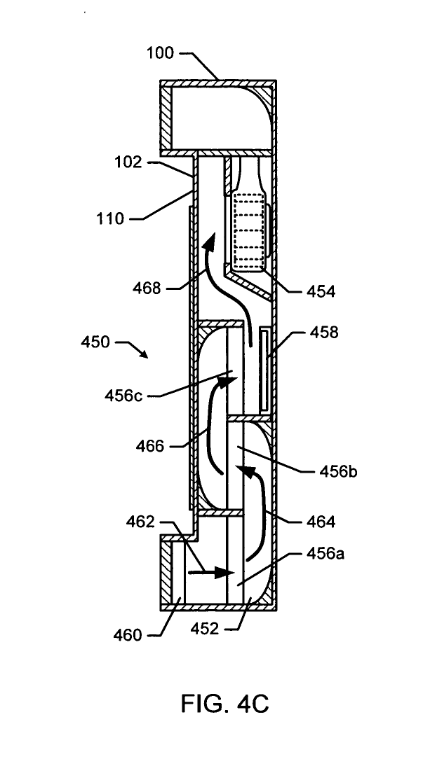

The intake vent 104 and the exhaust vent 106 are operatively coupled to the cabinet 102 and configured to protrude from the cabinet 102. A first aperture 124 and a second aperture 126 may be cut or otherwise formed in the first wall panel 114 to enable the intake vent 104 and the exhaust vent 106 to extend therethrough. Although the intake vent 104 and the exhaust vent 106 are shown as protruding from the first wall panel 114, the intake vent 104 and the exhaust vent 106 may be configured to be flush with the first wall panel 114. Additionally, the intake vent 104 is configured to enable ambient air to be moved into the cabinet 102 through the first aperture 124 in a direction generally indicated by arrow 128. The intake vent 104 may include a grate 130 and a pre-filter filter (e.g., the first pre-filter 410 of FIG. 4B). In one implementation, a layered structure or assembly for the intake vent 104 may include the grate 130. followed by the pre-filter. The pre-filter may be a large particle filter configured to filter out relatively large particles (e.g., dust, lint, hair, etc.) from the ambient air.

The exhaust vent 106 may be configured to enable processed air to exit the cabinet 102 through the second aperture 126 in a direction generally indicated by arrow 132. The exhaust vent 106 and the intake vent 104 are relatively distant from one another to reduce the amount of processed or output air exiting via the exhaust vent 106 that is immediately drawn into the intake vent 104. In this manner, the processed air is substantially circulated and mixed with ambient air before. being filtered again by the air processing apparatus.

The access door 108 is coupled to the front surface 110 via hinges 134 and may be configured to allow access to the air processing apparatus that is held within the cabinet 102. In this manner, the air processing apparatus within the cabinet 102 may be accessed for maintenance, inspection, and/or any other desired purpose. Although, the access door 108 is shown as being hinge-coupled to the front surface 110 via the hinges 134, the access door 108 may be coupled to the front surface 110 in any manner and configured to open in any manner including via complete removal. As shown in FIG. 1, the cabinet 102 is captured between the wall panels 114 and 116. Thus, to enable access to the access door 108, an access panel 136 may be formed in the first wall panel 114. The access panel 136 may be removably attached to the first wall panel 114 in any desired manner to enable access to the access door 108. Additionally, although the access door 108 is shown as being located on the front surface 110, the access door 108 may be located on the back surface of the cabinet 102 so that the access door 108 is adjacent to the second wall panel 116. In this configuration, the air processing apparatus held within the cabinet 102 may be accessed via an area or room other than the room to which the first wall panel 114 is exposed. In this manner, the access door 108, the access panel 136, and any maintenance or inspection of the air processing apparatus may be hidden from view and made as unobtrusive as possible to occupants of the area or room to which the first wall panel 114 is exposed.

The wall-embeddable air processing apparatus 100 may also be communicatively coupled to a control panel 138. In particular, the control panel 138 may be communicatively coupled to the air processing apparatus held within the cabinet 102 and may be configured to control various operating, inspection, and/or maintenance aspects of the air processing apparatus 100. For example, the control panel 138 may be communicatively coupled to a fan (e.g., the fan 404 of FIG. 4B) and used to control the speed of the fan. The control panel 138 may be mechanically coupled to the front surface 110. Alternatively, as shown in FIG. 1, the control panel 138 may be mechanically coupled to the first wall panel 114 and communicatively coupled to the wall-embeddable air processing apparatus 100 via any communication medium such as, for example, wires, optics, radio frequency (RF), etc.

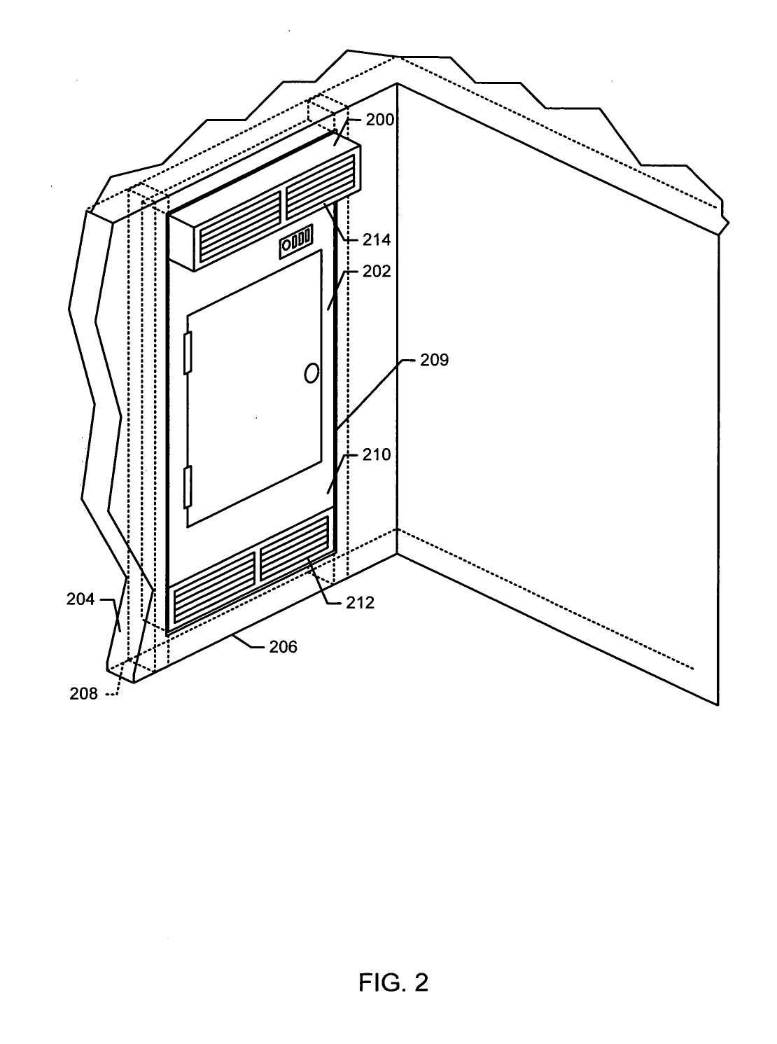

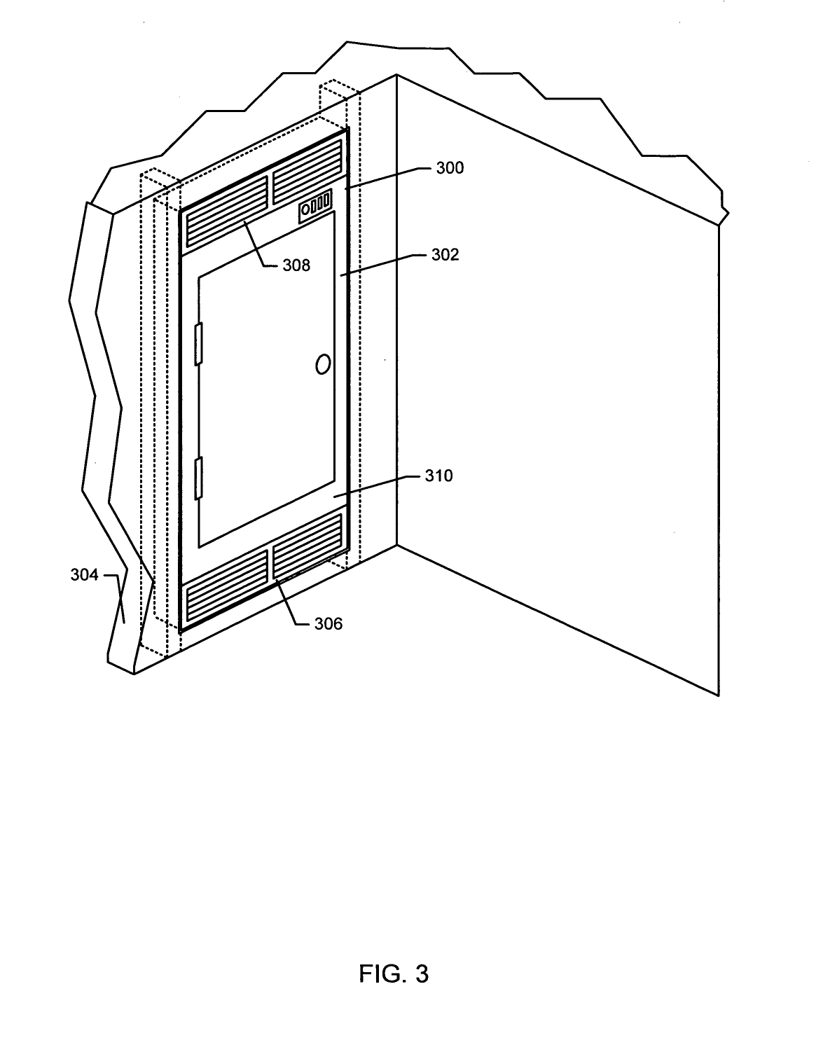

The wall-embeddable air processing apparatus 200 and 300 of FIGS. 2 and 3, respectively, are functionally similar to the wall-embeddable air processing apparatus 100. In particular, the wall-embeddable air processing apparatus 200 and 300 are configured to draw ambient air into their respective cabinets via respective intake vents and to exhaust processed air through respective exhaust vents. However, unlike the wall-embeddable air processing apparatus 100, respective cabinets 202 and 302 of the wall-embeddable air processing apparatus 200 and 300 are not captured or disposed between two wall panels of a wall structure. As shown in FIG. 2, the wall-embeddable air processing apparatus 200 is embedded in or installed in a wall structure 204 having a first wall panel 206, a second wall panel 208, and an aperture 209 formed in the first wall panel 206. The cabinet 202 of the wall-embeddable air processing apparatus 200 is installed within the aperture 209 and includes a front surface 210 that is substantially flush with the first wall panel 206 so that the front surface 210 is exposed to the area or room to which the first wall panel 206 is exposed. The cabinet 302 is embedded or installed in a wall structure 304 in a similar manner as shown in FIG. 3.

The wall-embeddable air processing apparatus 200 includes an intake vent 212 and an exhaust vent 214, both of which are operatively coupled to the cabinet 202 and both of which are functionally similar to the intake vent 104 and the exhaust vent 106 described above in connection with FIG. 1. As shown in FIG. 2, the intake vent 212 is substantially flush with the first wall panel 206 and the front surface 210. In contrast, the exhaust vent 214 protrudes from the first wall panel 206 and the front surface 210. Of course, the intake vent 212 and the exhaust vent 214 may both be configured to be substantially flush with the first wall 206 and the front surface 210 as shown in FIG. 3 In particular, as shown in FIG. 3, an intake vent 306 and an exhaust vent 308 are operatively coupled to the cabinet 302 and substantially flush with a front surface 310 of the cabinet 302.

FIG. 4A is a front elevational view and FIGS. 4B and 4C are example cross-sectional views of the example wall-embeddable air processing apparatus 100 of FIG. 1. FIG. 4A illustrates the front surface 110 of the cabinet 102 relative to the intake vent 104, the exhaust vent 106, and the access door 108. FIGS. 4B and 4C illustrate example air filtration apparatus 400 and 450 that may be used to implement an air processing apparatus configured to be held within the cabinet 102. In particular, as described below, elements of the example air filtration apparatus 400 and 450 are arranged within the cabinet 102 so that the cabinet 102 and the example air filtration apparatus 400 and 450 may be captured or disposed between two wall panels such as, for example, the wall panels 114 and 116, as described above in connection with FIG. 1. For example, air filter elements (e.g., the air filter elements 406a-406c of FIG. 4B and the air filter elements 456a-456c of FIG. 4C) may be arranged in low-profile configuration so that the depth or profile of the cabinet 102 may be substantially reduced, thus creating a relatively space efficient filter arrangement.

The example air filtration apparatus 400 and 450 are High Efficiency Particulate Air (HEPA) filtration apparatus. However, any other air filtration apparatus may be used instead of or in addition to the HEPA filtration apparatus including, for example, an ionic air filtration apparatus. In addition, although the example air processing apparatus held within the cabinet 102 is described as the example air filtration apparatus 400 or 450, the example air processing apparatus may be implemented using any other air processing apparatus such as, for example, a deionizer, a humidifier, a dehumidifier, etc.

As shown in FIG. 4B, the example air filtration apparatus 400 (i.e., the air filtration apparatus 400) is held within a plenum 402 that provides a flow path through which air may be drawn through the air filtration apparatus 400. The example air filtration apparatus 400 includes a fan 404, a plurality of air filter elements 406a-406c (i.e., a first air filter 406a, a second air filter 406b, and a third air filter 406c), and an ultraviolet lamp 408, all of which may be arranged within the plenum 402 as shown. In some implementations, the air filtration apparatus 400 may include one or more electronic apparatus (e.g., a processing system, sensors, etc.) that may be used to control operations of the air filtration apparatus 400.

The fan 404 may be a squirrel cage fan, a blower, or any other type of fan configured to draw ambient air into the cabinet 102 and push or exhaust processed air out of the wall-embeddable air processing apparatus 100. In particular, the fan 404 is configured to draw ambient air into the cabinet 102 via the intake vent 104 through a first pre-filter element 410 and the plurality of air filters 406a-406c to generate processed air or filtered air. The first pre-filter element 410 may be a large particle filter configured to remove or filter out relatively large particles (e.g., dust, lint, hair, etc.) from the ambient air. The air may then be drawn through the plurality of air filters 406a-406c.

The plurality of air filters 406a-406c may be arranged to sequentially filter ambient air that is drawn into the cabinet 102 by the fan 404. For example, the first air filter 406a may be a second pre-filter, the second air filter 406b may be a HEPA filter, and the third air filter 406c may be a charcoal filter. In particular, the first air filter 406a may be an electrostatic filter or a pleated filter having antimicrobial properties. The first air filter 406a may be used as a second pre-filter for ambient air that is drawn into the cabinet 102 to thoroughly remove relatively large pollutants or particles (e.g., dust, lint, etc.) from the ambient air that are not filtered out or captured by the first pre-filter 410. The HEPA filter used to implement the second air filter 406b may be used to capture bacteria, viruses, allergens (e.g., pollens, spores, smoke, etc.), and other relatively small organisms or particles that may be found in ambient air. The charcoal filter used to implement the third air filter 406c may be used to remove volatile organic compounds (VOC) (e.g., certain chemicals, gases, etc.) and odors from the ambient air.

As shown in FIG. 4B, the plurality of air filters 406a-406c are arranged in a skewed, angled, or slanted filter configuration relative to the front surface 110 of the cabinet 102 to create a low-profile configuration and reduce the depth or profile of the cabinet 102. Arranging the air filters 406a-406c in this manner ensures that the depth of the cabinet 102 is substantially equal to the width of wall studs (e.g., the width Ws of the wall studs 118 and 120 of FIG. 1), which enables the wall-embeddable air processing apparatus 100 to be disposed within two wall panels (e.g., the wall panels 114 and 116 of FIG. 1).

The ultraviolet lamp 408 may be configured to sterilize, clean, or at least destroy some organisms (e.g., bacteria) trapped by the third air filter 406c. The ultraviolet lamp 408 is shown at a location that enables the ultraviolet lamp 408 to direct ultraviolet light toward the third air filter 406c. However, the ultraviolet lamp 408 may be at any other location such as, for example, a location that allows the ultraviolet lamp 408 to direct ultraviolet light toward the first air filter 406a. In addition, although only one ultraviolet lamp is shown, any number of ultraviolet lamps may be located within the wall-embeddable air processing apparatus 100.

The example air filtration apparatus 450 illustrated in FIG. 4C includes an alternative filter arrangement that minimize the depth or profile of the cabinet 102. As shown in FIG. 4C, the example air filtration apparatus 450 is held within a plenum 452 and includes a fan 454, a plurality of air filter elements 456a-456c (e.g., a first air filter 456a, a second air filter 456b, and a third air filter 456c), an ultraviolet lamp 458, and a first pre-filter 460, all of which are functionally similar to the fan 404, the plurality of air filter elements 406a-406c, the ultraviolet lamp 408, and the first pre-filter element 410, respectively, described above in connection with FIG. 4B.

The filter elements 456a-456c are arranged in an edge-stacked filter configuration by mounting the filter elements 456a-456c in a vertical edge-to-edge filter configuration so that the filtration surfaces thereof are coplanar to one another and substantially parallel to the front surface 110 of the cabinet 102. The edge-stacked filter configuration enables the cabinet 102 to have a low-profile depth or a reduced depth. For example, the depth or profile of the cabinet 102 may be substantially equal to the width of wall studs (e.g., the width Ws of the wall studs 118 and 120 of FIG. 1), which enables the wall-embeddable air processing apparatus 100 to be disposed within two wall panels (e.g., the wall panels 114 and 116 of FIG. 1).

The edge-stacked filter configuration causes air to be drawn through the filter elements 456a-456c through a weave-like flow path or zigzag flow path having at least two changes in course. Specifically, the fan 454 may draw air into the cabinet 102 through the first pre-filter 460 and the first air filter 456a as indicated by arrow 462. Arrow 464 indicates a change in course of the flow path as the air is drawn away from the first air filter 456a and through the second air filter 456b. Arrow 466 indicates yet another change in course as the air is drawn away from the second air filter 456b and through the third air filter 456c. Subsequently, the air may be drawn away from the third filter 456c as indicated by arrow 468 and into the fan 454, which then exhausts processed air from the wall-embeddable air processing apparatus 100. The flow paths indicated by the arrows 462, 464, 466, and 468 form the weave-like flow path or the zigzag flow path through the edge-stacked filter elements 456a-456c. Thus, as ambient air is processed (i.e., filtered) by the example wall-embeddable air filtration apparatus 450, the processed air follows the weave-like flow path by weaving though each of the filter elements 456a-456c.

Although the fans 404 and 454 and the air filters 406a-406c and 456a-456c are shown as being located within the cabinet 102, the fans 404 and 454 and the air filters 406a-406c and 456a-456c may be located anywhere within the wall-embeddable air processing apparatus 100 such as, for example, in one or more plenums 412 and 414 adjacent to the intake vent 104 and the exhaust vent 106, respectively.

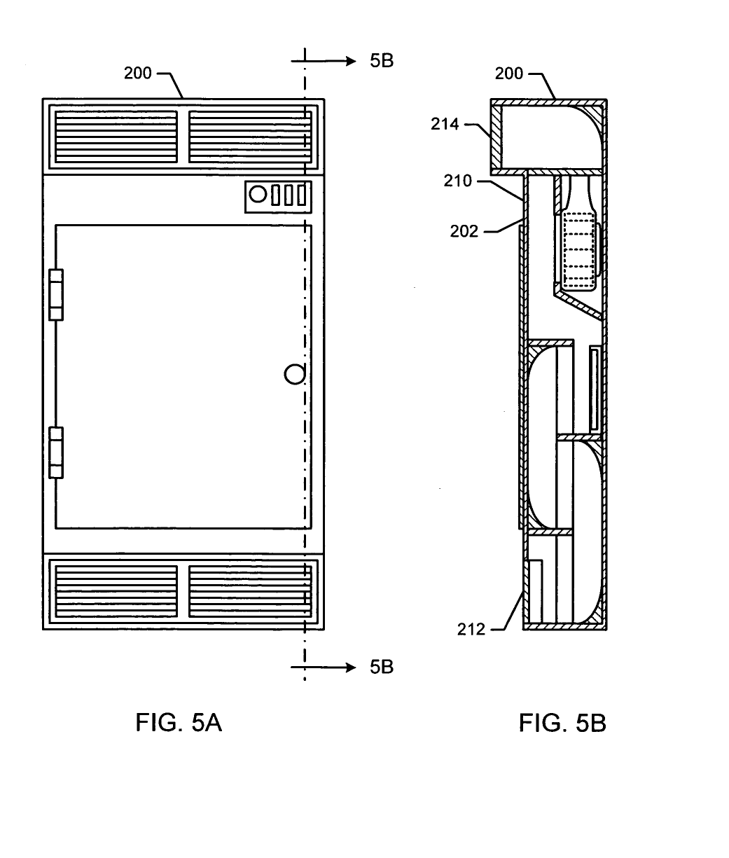

FIG. 5A is a front elevational view and FIG. 5B is an example cross-sectional view of the example wall-embeddable air processing apparatus 200 of FIG. 2. In particular, FIG. 5B illustrates the intake vent 212, which is substantially flush with the front surface 210 of the cabinet 202, and the exhaust vent 214, which protrudes from the cabinet 202. Although, the example wall-embeddable air processing apparatus 200 is illustrated in FIG. 5B as having the filter arrangement described above in connection with FIG. 4C, the example wall-embeddable air processing apparatus 200 may alternatively include the filter arrangement described above in connection with FIG. 4B, and/or any other suitable filter arrangement.

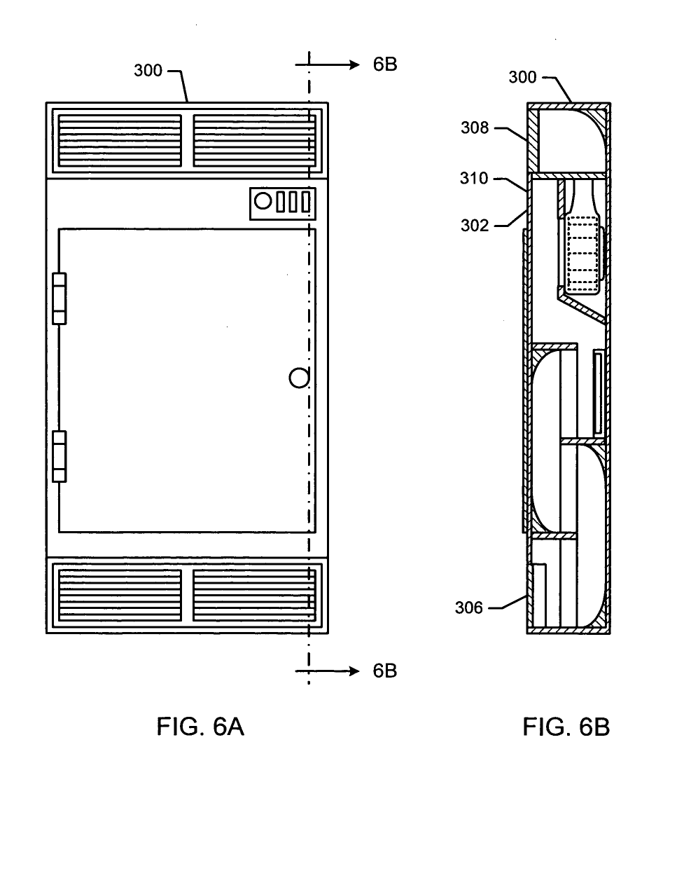

FIG. 6A is a front elevational view and FIG. 6B is an example cross-sectional view of the example wall-embeddable air processing apparatus 300 of FIG. 3. In particular, FIG. 6B illustrates the intake vent 306 and the exhaust vent 308, which are substantially flush with the front surface 310 of the cabinet 302. Although, the example wall-embeddable air processing apparatus 300 is illustrated in FIG. 6B as having the filter arrangement described above in connection with FIG. 4C, the example wall-embeddable air processing apparatus 300 may alternatively include the filter arrangement described above in connection with FIG. 4B, and/or any other suitable filter arrangement.

Although certain apparatus, methods, and articles of manufacture have been described herein, the scope of coverage of this patent is not limited thereto. To the contrary, this patent covers all apparatus, methods, and articles of manufacture fairly falling within the scope of the appended claims either literally or under the doctrine of equivalents.

What is claimed is:

1. A wall-embeddable air processing apparatus, comprising:
a cabinet having substantially parallel first and second surfaces;
a plurality of air filter elements located within the cabinet and arranged so that filtration surfaces of the filter elements are substantially coplanar to each other and substantially parallel to the first and second surfaces;
an intake vent operatively coupled to the cabinet and configured to enable ambient air to be drawn into the cabinet; and
a fan operatively coupled to the cabinet and configured to draw the ambient air into the cabinet and to cause the ambient air to flow through the plurality of air filter elements to generate processed air.

2. A wall-embeddable air processing apparatus as defined in claim 1, wherein the plurality of filter elements are arranged in an edge-stacked filter configuration.

3. A wall-embeddable air processing apparatus as defined in claim 1, wherein the ambient air flows through the plurality of air filter elements via a weave-like flow path or a zigzag flow path.

4. A wall-embeddable air processing apparatus as defined in claim 1, wherein the ambient air flows through the plurality of air filter elements via a flow path having at least two changes in course.

5. A wall-embeddable air processing apparatus as defined in claim 1, wherein the fan is a squirrel-cage fan or a blower.

6. A wall-embeddable air processing apparatus as defined in claim 1, wherein the intake vent protrudes from the cabinet.

7. A wall-embeddable air processing apparatus as defined in claim 1, wherein the cabinet is configured to fit between and abut first and second support members.

8. A wall-embeddable air processing apparatus as defined in claim 7, wherein the first and second support members are first and second wall studs of a wall structure.

9. A wall-embeddable air processing apparatus as defined in claim 7, wherein the cabinet is configured to be mechanically coupled to the first and second support members via a plurality of fasteners.

10. A wall-embeddable air processing apparatus as defined in claim 1, further comprising an access door hinge-coupled to the first surface and configured to allow access to the plurality of air filter elements.

11. A wall-embeddable air processing apparatus as defined in claim 1, further comprising a control panel communicatively coupled to the fan and configured to enable varying a speed of the fan.

12. A wall-embeddable air processing apparatus, comprising:
a cabinet;
an air filter element located within the cabinet and arranged so that the cabinet has a depth that enables the cabinet to be disposed substantially between first and second wall panels and first and second support members, wherein the first and second wall panels are separated by a distance substantially equal to a width of the first or second support member;
an intake vent operatively coupled to the cabinet and configured to enable ambient air to be drawn into the cabinet through an aperture formed in the first wall panel; and
a fan operatively coupled to the cabinet and configured to draw the ambient air into the cabinet and to cause the ambient air to flow through the air filter element to generate processed air.

13. A wall-embeddable air processing apparatus as defined in claim 12, wherein the first and second support members are first and second wall studs.

14. A wall-embeddable air processing apparatus as defined in claim 12, wherein the air filter element is arranged in an edge-stacked filter configuration or a slanted filter configuration.

15. A wall-embeddable air processing apparatus as defined in claim 12, wherein a filtration surface of the air filter element is substantially parallel to the first wall panel.

16. A wall-embeddable air processing apparatus as defined in claim 12, wherein the air filter element and another filter element are arranged within the cabinet to cause the ambient air to flow through a weave-like or zigzag flow path.

17. A wall-embeddable air processing apparatus as defined in claim 12, wherein the ambient air flows through the cabinet via a flow path having at least two changes in course.

18. A wall-embeddable air processing apparatus as defined in claim 12, wherein the cabinet is configured to abut the first and second support members and to be mechanically coupled thereto.

19. A wall-embeddable air processing apparatus as defined in claim 12, wherein the intake vent protrudes from the cabinet.

20. A wall-embeddable air processing apparatus as defined in claim 12, wherein the low-profile depth of the cabinet is substantially equal to a width of the first or second support member.

21. A wall-embeddable air processing apparatus, comprising:
a cabinet configured to be mounted substantially within a wall structure having first and second wall panels and first and second wall studs captured therebetween, wherein the cabinet is configured to be disposed between and mounted to the first and second wall studs;
an intake vent operatively coupled to the cabinet and configured to enable ambient air to be drawn into the cabinet through an aperture formed in the first wall panel;
an air filter element located within the cabinet and arranged in a low-profile filter configuration; and
a fan operatively coupled to the cabinet and configured to draw ambient air into the cabinet and to cause the ambient air to flow through the air filter element.

22. A wall-embeddable air processing apparatus as defined in claim 21, wherein the cabinet is configured to abut the first and second wall studs.

23. A wall-embeddable air processing apparatus as defined in claim 21, wherein the low-profile filter configuration is an edge-stacked filter configuration or a slanted filter configuration.

24. A wall-embeddable air processing apparatus as defined in claim 21, wherein the ambient air flows through the air filter element via a weave-like or zigzag flow path.

25. A wall-embeddable air processing apparatus as defined in claim 21, wherein the ambient air flows through the cabinet via a flow path having at least two changes in course.

26. A wall-embeddable air processing apparatus as defined in claim 21, wherein a filtration surface of the air filter element is substantially parallel to the first wall.

27. A wall-embeddable air processing apparatus as defined in claim 21, wherein the intake vent protrudes from the cabinet.

28. A wall-embeddable air processing apparatus as defined in claim 21, further comprising an access door hinge-coupled to the cabinet and configured to allow access to the air filter element.
